(19) United States
(12) Patent Application Publication
(10) Pub. No.: US 2024/0325995 A1
(43) Pub. Date: Oct. 3, 2024

(54) DEVICE FOR PURIFYING AN AIR-WATER CURRENT

(71) Applicant: WINGSCOMPANY, S.L., Málaga (ES)

(72) Inventor: Francisco Javier Marin Garcia, San Vincente del Raspeig, Alicante (ES)

(73) Assignee: WINGSCOMPANY, S.L., Malaga (ES)

(21) Appl. No.: 18/277,793

(22) PCT Filed: Feb. 10, 2022
(86) PCT No.: PCT/ES2022/070066

§ 371 Date: Dec. 28, 2023

(30) Foreign Application Priority Data
Feb. 19, 2021 (ES) U202130343

(51) Int. Cl. B01F 25/452; B01F 23/232; B01F 23/237; B01F 23/2375; B01F 33/81; B01F 35/221; B01F 101/04; C02F 1/74; C02F 1/78

(52) U.S. Cl. CPC B01F 25/4521; B01F 23/232; B01F 23/2375; B01F 23/237611; B01F 23/237612; B01F 23/237613; B01F 33/811; B01F 35/2213; C02F 1/74; C02F 1/78; B01F 2101/04; C02F 2303/02; C02F 2303/04

(57) ABSTRACT

An air-water current purifying device allows the size of the bubbles from the mixture to be reduced includes an inlet for the air-water mixture; a first filter occupying the cross-section of the device, with a plurality of holes; a first expansion chamber after the first filter; a second filter with the same characteristics and arrangement as the first filter and located after the first expansion chamber; a second expansion chamber after the second filter; a third filter after the second expansion chamber, with the same features and arrangement as the first and second filters; a third expansion chamber after the third filter; a pressure-regulating valve arranged at the outlet of the device; and a regulating flywheel that allows the valve to be closed and opened.

### OBJECT OF THE INVENTION

The present invention consists of a device for the purification of water, by passing a stream of water from a pump into which air has been injected, through the different cavities of said device, which allows it to be installed on a small scale or for a large water treatment installation.

### BACKGROUND OF THE INVENTION

In a large number of chemical or physical processes, particularly in drying and combustion processes, it is of great importance to obtain reactive micro drops of fluid. A fluid for this purpose is usually pressed through a specially designed spray nozzle, which sprays or disperses the fluid. Dispersion can also be performed with the aid of steam or compressed air, while these methods are not used with small amounts of fluid.

It is also generally known how to improve or accelerate the exit of a stream of fluid from a nozzle through a gas flow surrounding the emerging jet concentrically. However, the gas flow is not intended to disperse the fluid exiting the nozzle, but rather, to hold the fluid stream together. Finally, it is also known how to transfer a rotational movement to the thin gas film that holds the fluid stream together or also a droplet sponge, to obtain a rotation of the fluid stream itself. However, also with this known solution, the intention is to avoid fluid dispersion or additional fine dispersion.

International patent application WO/1997/002096 reveals a lubricant mist nozzle designed to provide a discrete liquid droplet exit. The nozzle has a particular application in conjunction with aerosol lubrication systems where it is desired to direct a lubricant stream focused towards a device to be lubricated. The nozzle is specially adapted for use in connection with mist oil lubrication units, it removes mist oil from the carrier gas, gathers the extracted oil, and/or reintroduces it into the carrier gas flow so that it can be sprayed in the form of a uniformly-sized set of droplets to a target to be lubricated. The nozzle may include a helical flow path for the mist, during which the mist oil is drawn from the unit, and a needle-shaped assembly that gathers the extracted oil and channels it into the nozzle gas flow as it exits the nozzle.

Conventional systems for purifying water in water reservoirs such as water tanks, pools, and the like include a filtration apparatus for removing dust and the like in water.

The filter is problematic in terms of maintenance as it is often clogged. The cyclone is more satisfactory in the degree of air purification and cannot be applied to indoor sports institutions, let alone indoor swimming pools that must undergo air purification containing gaseous chlorine. Water filtration systems cannot be used to eliminate bad odors.

In the field of appliances designed to counteract contamination in large bodies of water contained in natural pools, devices called oxygenators are currently used that cause the mixing of water with air by pumping. These devices may consist of floating turbine pumps that suck in water and expel it back into the pool, thus facilitating the restoration of the balance conditions between atmospheric oxygen and dissolved oxygen in the water. However, these devices have been shown to have a limited utility to the extent that they facilitate the diffusion of oxygen into surface water layers only, while this diffusion process is not suitable to involve deeper water layers. Other devices that act in deep water layers (e.g., bubble guns, Limo oxygenators, and the like) are known, however, their action is limited to limited pool areas; furthermore, they do not anticipate the use of oxygen or do not anticipate the recovery of undissolved oxygen when using this gas.

It is common to use a blower or pump to generate air pressure that is channeled to a chamber under the line and then to the line through a number of holes at the bottom of the line. Since water will flow back through the air supply line when the blower is not operating, the blower is normally placed above the water line to prevent it from being damaged by the backflow of water from the line. However, for aesthetic reasons, it is desirable to locate the blower below water level, but to do so, some means must be used to prevent water from backing into the blower when the blower is off.

The Spanish utility model ES0281762 reveals an injector nozzle to produce turbulence in bathtubs, pools and the like, which is essentially characterized by being comprised of a monopiece body determined by two parallel bushings joined by a common wall in which a truncoconical orifice appears as a Venturi device, from which the bushings are normally smaller in diameter than their contiguous ones and, from it, a perpendicular tubular part with external thread and a stopper pad is derived, while the other bushing has a hole opposite that which is fileted and intended to allow the machining of the central truncal-conical hole, this nozzle being completed with two additional caps, with some joints, a washer, a tightening nut, a concealment cover, and a dedicated terminal tubular nut.

The present invention solves the problems presented in the art, since it proposes a device capable of causing a water-air mixture to produce micro and nano bubbles, such that these micro or nano bubbles move randomly through the water and remain suspended in the water for long periods of time, acting as a generator that delivers oxygen and/or ozone continuously to all of the water. Due to the long dwelling time of the micro and nano bubbles and the enormous contact surface between the gas bubble and the water, the oxygen dissolves very efficiently. The device can be applied in various activities, this technology being capable of reducing harmful algae in water during the summer and improving the overall quality of the water, by means of two actions, first by distributing oxygen and/or ozone from the surface to the ground and through oxidation. Increasing the growth of your agricultural crops, improving their quality, saving on costs and contributing to cleaner production are some of the benefits provided by the device of the invention.

### A DESCRIPTION OF THE DRAWINGS

To complement the description being made and to help better understand the characteristics of the invention, in accordance with a preferential example of the practical realization thereof, a set of drawings is attached as an integral part of said description, wherein, by way of example and not limitation, the following has been represented:

FIG. 1 shows an internal view of the arrangement of elements within the device (10) with the valve open, where alternating cavities (40), (40′), and (40″) and filters (50), (50′), and (50″) can be seen.

FIG. 2. —shows an internal view of the arrangement of elements within the device (10) with the valve closed, where alternating cavities (40), (40′), and (40″) and filters (50), (50′), and (50″) can be seen.

FIG. 3. —shows a view of the filter inlet surface (50), where the inlet holes (60a) can be seen.

FIG. 4. —shows a view of the filter surface (50), where the exit holes (60b) can be seen.

FIGS. 5A to 5D. —show diagrams depicting the results obtained in tests performed with the device subject to the present invention, where FIG. 5A shows the results of nanobubble generation when fed with oxygen; FIG. 5B shows the results of nanobubble generation when fed with ozone; where FIG. 5C shows the results of nanobubble generation, when it is ozone generated with atmospheric air supply and the oxidizing potential is shown (Redox); and FIG. 5D displays nanobubble generation results when it is oxygen-powered ozone and the oxidizing potential (Redox) is displayed. These diagrams refer to unsaturated tap water as to =0, while t=0 min and remaining values t refer to saturated water.

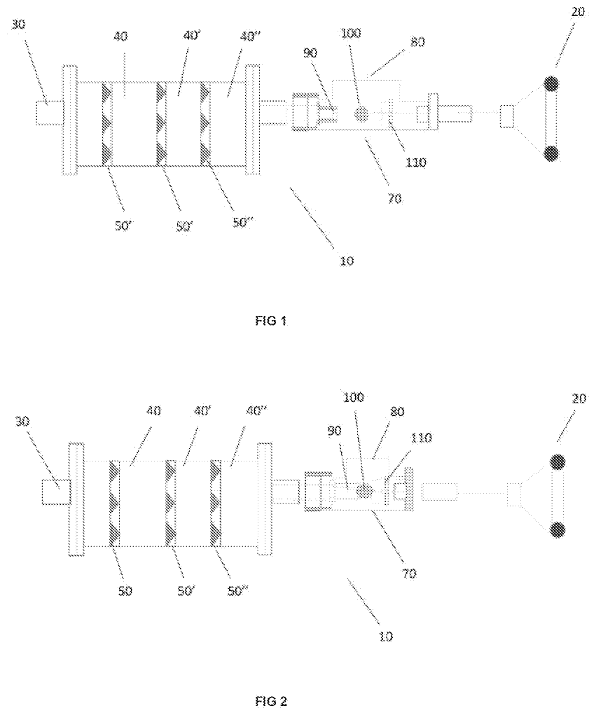

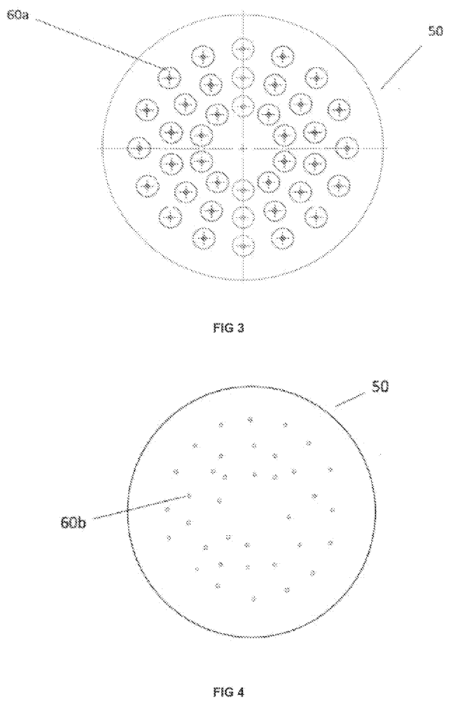

### THE PREFERENTIAL EMBODIMENT OF THE INVENTION

The present invention reveals a device that allows the purification of water by the action of passing a water-air current through it, this action of passing the mixture producing a decrease of bubbles to levels of micro or nano bubbles, which remain suspended in the water for long periods of time, acting as a generator that delivers a gas, such as oxygen and/or ozone, continuously to all of the water. At this point, it is noted that the term air is not intended to be limiting, but rather refers to a substance in a gaseous state or a gas, which can be injected into the device. In the preferred embodiments of the invention, the gas injected into the air-water mixture is selected from oxygen, ozone, atmospheric air, or a mixture of at least two of them, although other compounds could also be used, as could nitrogen, which is the main component of atmospheric air.

The water purification device (10) incorporates a number of filters (50), (50′), and (50″) with perforations (60a) and (60b), all with equal dimensions and characteristics, which are arranged next to each other leaving an expansion chamber between consecutive filters. That is, between the filters (50) and (50′), there is a first expansion chamber (40), between the filter (50′) and (50″), there is a second expansion chamber (40′), and at the exit of the third filter (50″), there is a third expansion chamber (40″).

The perforations (60a) and (60b) carried out on the filters (50), (50′), and (50″) are disposed on the surface of the filters (50), (50′), and (50″), forming a circular region, and each of the perforations (60a) and (60b) are practiced such that the surface of the perforation in the inlet section (60a) is greater than the surface of the perforation (60b) in the exit section, i.e. between the perforations (60a) and (60b), a conical, Venturi-type cavity is created.

The air-water mixture purification device (10) of the invention allows to form part of a system including a pump connected to a water input and a capillary that allows gas to be injected into said pump and wherein the device (10) receives a stream of water and air from the pump, where the injected gas is oxygen, ozone, atmospheric air, and/or a mixture of at least two of them, and comprising: an inlet (30) for the air water mixture; a first filter (50) occupying the cross-section of the device (10) with a number of perforations (60), wherein the inlet perforations (60a) have a greater surface area than the exit perforations (60b) and wherein the inlet of the water-air mixture to the filter (50) is made by the perforation (60a) with a greater surface area and the exit of the mixture is made by the perforation with less surface area (60b); there is a first expansion chamber (40) following said first filter (50); there is a second filter (50′) having the same characteristics and arrangement as the first filter (50), occupying the cross section of the device (10) and following the first expansion chamber (40); there is a second expansion chamber (40′) following said second filter (50′); there is a third filter (50″) following the second expansion chamber (40′), having the same characteristics and arrangement as the first (50) and second (50′) filters; there is a third expansion chamber (40″) following said second filter (50′); there is a pressure regulating valve (70) arranged at the exit (80) of the device (10), composed of a conical-ended bushing (90); there is a stainless steel ball (100) closing said tapered bushing by contacting a rubber plug (110) (rubber silentblock) to dampen the pressure; and a regulating flywheel (20) that allows the valve (70) to be closed and opened.

The device may have a greater number of filter combinations (50), (50′), and (50″) according to the dimensions of the device (10), but always maintaining the sequence described.

The usual shape and characteristic of this type of perforation (60a), (60b) in the filters (50), (50′), and (50″), to originate small cone-shaped cavities, first laying the inlet of the larger surface perforation (60a) towards an exit with the smaller surface perforation (60b). This causes the air bubble to decrease in such a way that, when a rotation is generated, it allows the bubbles to be broken by converting them into smaller ones.

The number of filters (50), (50′), (50″), and perforations (60), their arrangement, measurements and location may vary depending on the internal assembly of the device (10) and variables such as water flow and pressure.

The device (10) allows water current to reach the device from a pump, into which air has been injected through a capillary. This mixture exits the pump to the device (10). It enters the device (10) through the inlet mouth (30) and first passes through the filters (50), causing the size of the generated bubbles to decrease, then the water flow passes through the first expansion chamber (40), where the decreased bubbles pass through a second filter (50′) with the same characteristics as the filter (50) and in the same arrangement that causes a new decrease of the bubbles and, at the exit, passes through a second expansion chamber (40′) where the decreased bubbles pass through a third filter (50″) with the same characteristics as the filters (50) and (50′) and in the same arrangement, This combination allows the bubbles to be reduced as much as to the level of micro or nano bubbles at the exit of said third filter (50″). When the water-air mixture has exited the device (10), the regulating valve (70) allows to control the exit of the mixture and maintain the size of the bubbles; the closing and opening of the valve (70) is carried out by means of a regulating wheel (20) that, by turning clockwise or counterclockwise closes or opens said regulating valve (70), maintaining control of the device (10). It is important to note that the ball (100) produces movements due to the pressure that stirs the water, enhancing the result.

Micro or nano bubbles are extremely small bubbles, one million times smaller than small visible bubbles. They have the ability to change the normal characteristics of water, as essentially, there is no loss of oxygen or other gas escaping into the atmosphere.

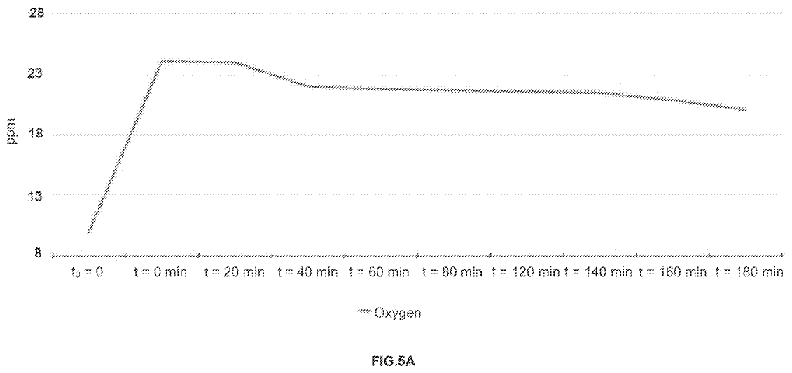

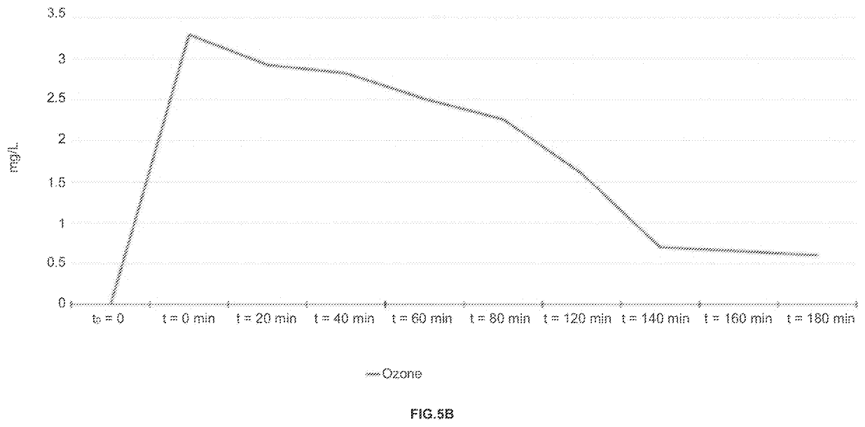

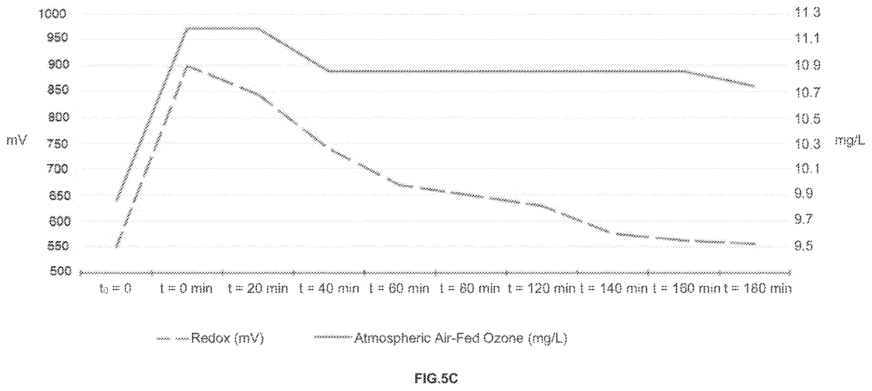

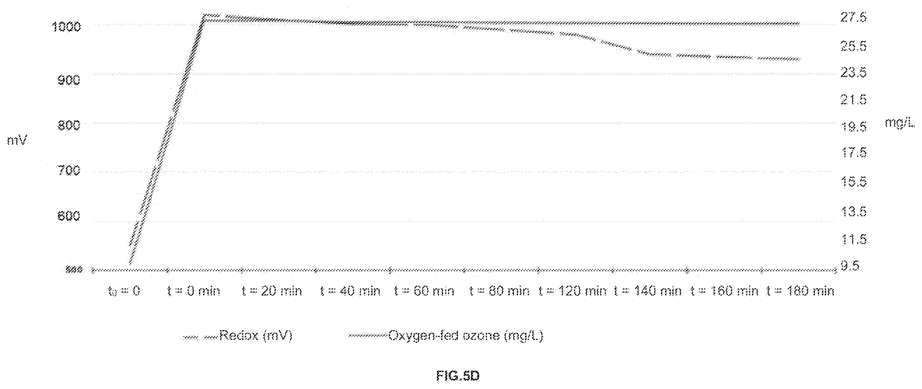

As can be seen in the images of FIG. 5A-5D, by generating nanobubbles with the tests performed on the device that is the object to the present invention with atmospheric air, pure oxygen, and pure ozone and, based on measurements on the resulting nanobubble with specific laboratory equipment for this purpose, very high levels of concentration in oxygen, ozone, and oxidizing potential (Redox) have been observed in the resulting waters.

For that reason, the use of the device that is the object of the present invention is oriented towards agriculture, and, for example, as a treatment for irrigation with pooled waters, specifically to the generation of nanobubbles high in soluble oxygen for irrigation in agriculture; for the generation of nanobubbles high in soluble ozone for use as an oxidizing pesticide or biocide in the agricultural sector; and/or for the generation of nanobubbles high in ozone and soluble oxygen for use as a treatment of odors and the decomposition of irrigation pools.

In this regard, the use of oxygen gas for the generation of nanobubbles with a high content of soluble oxygen for the irrigation of all types of plants (Greenhouses, Olive Groves, Fruit Trees, or others) and any type of cultivation to which oxygen can be contributed via nanobubbles, is based on the advantage that oxygen gas does not escape to the atmosphere, following a liquid/gas physical law beyond the maximum solubility of oxygen in water at a given pressure and temperature. The oxygen content remains in the water for long periods of time at a high concentration until it is absorbed by the plant and, since it is at the level of nanometers, it facilitates absorption by it. The use of ozone gas for the generation of nanobubbles with a high soluble ozone content for use as a pesticide or as a high lethality oxidizing biocide in all types of plants (Greenhouses, Olive Groves, Fruit Trees, or others), and any type of crop that requires pesticide application processes. Application for sterilizing agricultural soils and the crowns and leaves of trees, where the advantage is that ozone gas does not escape to the atmosphere following a liquid/gas physical law beyond the maximum solubility of ozone in water at a given pressure and temperature and the ozone content remains in the water for long periods of time at a high concentration while, in gas form, it lasts for a few seconds and, since it is at the level of nanometers, it facilitates absorption by the plant. In this case, it is noted that ozone is lethal to more than 90% of pathogens at concentrations above 1.5 ppm and that, above a redox of 650-700 mV, life is virtually impossible (for example, Escherichia Coli bacteria do not survive a redox of 650 mV and are eliminated on the spot). The diagrams in FIG. 5C-5D show the usefulness of the present invention. For its part, the use of Ozone gas for the generation of nanobubbles high in ozone and soluble oxygen for use as a treatment of odors and the decomposition of irrigation pools thanks to the biocidal oxidative action of ozone and the generation of aerobic conditions of oxidative redox due to the high concentration of oxygen that prevent the fermentation and putrefaction processes of standing water, where the ozone content remains in the water longer, allowing for a greater disinfecting action and, in turn, to avoid oxygen consumption that impoverishes waters, resulting in decomposition.

In this line, it is important to note that the operation of the device of the invention can ensure that the quality of the water is improved structurally and not temporarily as with aeration or traditional chemical products; this allows the water to be enriched with oxygen and/or ozone in different irrigation locations, avoiding the application of chemical products to improve the quality of the water.

1-8. (canceled)

9: A device for purifying an air-water stream that decreases the size of the bubbles from said mixture defining a cross section therein, comprising:
an inlet for the water-air mixture having a first plurality of perforations on the inlet being inlet perforations;
an outlet having a second plurality of perforations on the outlet being outlet perforations
a first filter occupying the cross-section;
a first expansion chamber following the first filter occupying the cross-section;
a second filter with the same characteristics and arrangement as the first filter occupying the cross-section and the first expansion chamber;
second expansion chamber following the second filter;
a third filter following the second expansion chamber with the same characteristics and arrangement as the first filter and the second filter;
a third expansion chamber following said second filter;
a pressure regulating valve disposed at the outlet having a conical end cap;
a stainless steel ball that closes the conical bushing via contact with a rubber stud to dampen the pressure; and
a regulating wheel that allows the valve to be closed and opened;
wherein the inlet perforations have greater surface than the outlet perforations;
wherein the water-air mixture flows to the first filter through the inlet perforations and from the outlet perforations.

10: The device of claim 9, wherein surface of the inlet perforations is greater than the surface of the outlet perforations to cause a conical cavity of the venturi type.

11: The device of claim 9, wherein the first filter, the second filter, and the third filter have equal dimensions and characteristics.

12: The device of claim 9, wherein the first filter, the second filter, and the third filter have predetermined arrangements, measurements, and locations based upon at least one of water flow rate and pressure.

13: The device of claim 9, wherein the number of inlet perforations and the number of the outlet perforations are based upon at least one of water flow rate and pressure.

14: The device of claim 9, wherein the injected gas in the air-water mixture is selected from the group consisting of oxygen, ozone atmospheric air, and a mixture of oxygen and ozone atmospheric air.

15: The device of claim 9, adapted for use in agriculture.

16: The device of claim 9, adapted for use in the treatment of irrigation packaged water.
